(19) United States
(12) Patent Application Publication
(10) Pub. No.: US 2022/0288785 A1
(43) Pub. Date: Sep. 15, 2022

(54) CONTROL DEVICE, CONTROL METHOD, AND PROGRAM

(71) Applicant: JOHNAN Corporation, Uji-shi, Kyoto (JP)

(72) Inventors: Kozo MORIYAMA, Uji-shi (JP); Shin KAMEYAMA, Uji-shi (JP); Truong Gia VU, Uji-shi (JP); Lucas BROOKS, Uji-shi (JP)

(73) Assignee: JOHNAN Corporation, Uji-shi, Kyoto (JP)

(21) Appl. No.: 17/635,205

(22) PCT Filed: Aug. 27, 2020
(86) PCT No.: PCT/JP2020/032337

§ 371 Date: Feb. 14, 2022

(30) Foreign Application Priority Data
Aug. 30, 2019 (JP) 2019-157953

(51) Int. Cl. B25J 9/16; B25J 19/02

(52) U.S. Cl. CPC B25J 9/1676; B25J 9/1666; B25J 9/1651; B25J 19/023

(57) ABSTRACT

A control device, for controlling a robot that performs a task, according to one or more embodiments may be configured to cause the robot to perform the task. When a distance between the robot and a person is less than a predetermined value, the control device may be configured to change a movement path of the robot and to adjust the predetermined value in accordance with a workpiece held by the robot.

### TECHNICAL FIELD

The present invention relates to a control device, a control method, and a program.

### BACKGROUND ART

Conventional techniques have disclosed devices for monitoring the working environment of a robot (for example, see PTL 1).

A known device for monitoring the working environment of a robot is equipped with a camera for capturing an image of a work area of a robot, and a computer for detecting a moving object based on a result of an image captured by the camera. When the computer detects a moving object and finds that the moving object is approaching the robot, the computer is configured to issue a warning on a display and to handle the situation, for example, by stopping the robot.

### CITATION LIST

### Patent Literature

PTL 1: JP H05-261692 A

### SUMMARY OF INVENTION

### Technical Problem

When a distance between the robot and a person is less than a predetermined value, a conceivable solution is to cause the robot to perform an approach-handling process. Nevertheless, at the time of determining whether to cause the robot to perform the approach-handling process, the known device does not consider a workpiece held by the robot, and needs improvements in this regard.

The present invention is made to solve the above problem, and aims to provide a control device, a control method, and a program that can cause a robot to perform an approach-handling process with suitable timing in accordance with a workpiece held by the robot.

### Solution to Problem

A control device according to the present invention is a device for controlling a robot that performs a task. The control device includes: a task execution section that causes the robot to perform the task; an approach-handling process execution section that causes the robot to perform an approach-handling process when a distance between the robot and a person is less than a predetermined value; and a predetermined value adjustment section that adjusts the predetermined value in accordance with a workpiece held by the robot.

In this configuration, the predetermined value for determining whether to cause the robot to perform the approach-handling process is adjusted in accordance with the workpiece held by the robot. This configuration can cause the robot to perform the approach-handling process with suitable timing in accordance with the workpiece.

A control method according to the present invention is a method for controlling a robot that performs a task. The control method includes: a step of causing the robot to perform the task; a step of causing the robot to perform an approach-handling process when a distance between the robot and a person is less than a predetermined value; and a step of adjusting the predetermined value in accordance with a workpiece held by the robot.

A program according to the present invention causes a computer to implement: a procedure for causing a robot to perform a task; a procedure for causing the robot to perform an approach-handling process when a distance between the robot and a person is less than a predetermined value; and a procedure for adjusting the predetermined value in accordance with a workpiece held by the robot.

### Advantageous Effects of Invention

The control device, the control method, and the program according to the present invention can cause the robot to perform the approach-handling process with suitable timing in accordance with a workpiece held by the robot.

### BRIEF DESCRIPTION OF DRAWINGS

FIG. 1 is a block diagram showing a general configuration of a robot control system according to a first embodiment.

FIG. 2 is a flowchart describing an operation of the robot control system according to the first embodiment.

FIG. 3 is a block diagram showing a general configuration of a robot control system according to a second embodiment.

FIG. 4 is a flowchart describing an operation of the robot control system according to the second embodiment.

### DESCRIPTION OF EMBODIMENTS

Embodiments of the present invention are described below.

### First Embodiment

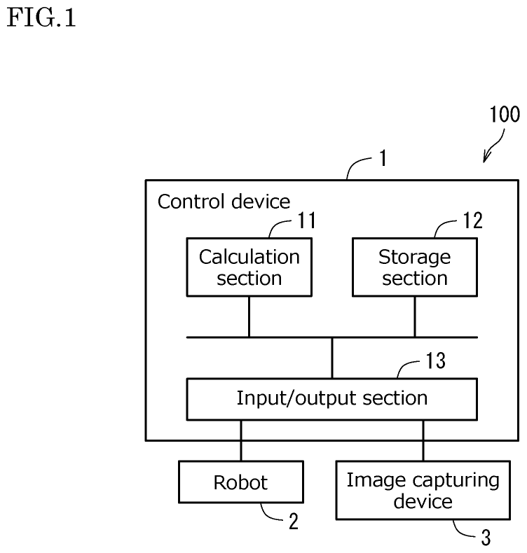

Referring to FIG. 1, a description is made of a configuration of a robot control system 100 that includes a control device 1 according to the first embodiment of the present invention.

The robot control system 100 is applied to a factory floor, for example, and is configured to cause a robot 2 to perform a predetermined task (work) on the factory floor. This robot control system 100 does not separate the robot 2 by a fence or the like, and keeps a work area of the robot 2 accessible to a person. As shown in FIG. 1, the robot control system 100 includes the control device 1, the robot 2, and an image capturing device 3.

The control device 1 is configured to control the robot 2 that performs a task. This task is a work to be done by the robot 2 alone and, for example, includes transferring a workpiece W from a point P1 to a point P2. Accordingly, while workpieces W are sequentially supplied to the point P1, these workpieces W are sequentially transferred to the point P2 through repetitive execution of the task by the robot 2. The movement path of the robot 2 moving between the points P1 and P2 is set in advance. Note that the movement path of the robot 2 is configured to be modifiable.

The control device 1 includes a calculation section 11, a storage section 12, and an input/output section 13. The calculation section 11 is configured to control the control device 1 by performing arithmetic processing based on programs and the like stored in the storage section 12. The storage section 12 stores a program for causing the robot 2 to perform the task, and other like programs. The input/output section 13 is connected to the robot 2, the image capturing device 3, etc. Note that “the task execution section”, “the approach-handling process execution section”, and “the predetermined value adjustment section” in the present invention are implemented when the calculation section 11 executes the programs stored in the storage section 12. Also note that the control device 1 is an example of “the computer” in the present invention.

The robot 2 has a multi-axis arm and a hand, for example. The multi-axis arm is mounted on a base. The hand, as an end effector, is provided at an extreme end of the multi-axis arm. The robot 2 is configured to hold a workpiece by the hand and to transport the workpiece held by the hand.

The image capturing device 3 is installed to recognize the workpiece held by the robot 2 and to calculate a distance D between the robot 2 and a person. The distance D is, for example, the shortest distance from the multi-axis arm of the robot 2, the hand of the robot 2, and the workpiece held by the hand of the robot 2, to the human body. The image capturing device 3 is configured to capture, for example, an image of a work area of the robot 2. The work area of the robot 2 is an area surrounding the robot 2, and covers an area in which the robot 2 moves and the workpiece held by the robot 2 passes during the work. The result of an image captured by the image capturing device 3 is input to the control device 1. Accordingly, the control device 1 is configured to control the robot 2, based on the result of an image captured by the image capturing device 3 and any other relevant factor.

When the distance D between the robot 2 and the person is equal to or greater than a predetermined value PVa, the control device 1 is configured to cause the robot 2 to perform the task repetitively. For example, the robot 2 is caused to transfer the workpiece W sequentially from the point P1 to the point P2. During this task, the robot 2 is caused to move between the points P1 and P2 along a preset movement path.

When the distance D between the robot 2 and the person decreases to less than the predetermined value PVa, the control device 1 is configured to change the movement path of the robot 2 and to cause the robot 2 to perform the task repetitively under the changed condition. The changed movement path is set such that the distance D increases to the predetermined value PVa or greater, for example, based on a position of the person or other like factors. The movement speed after the movement path change is set, for example, just as before the movement path change. Take the following case as an example: when a person approaches the robot 2 that is performing the task and the distance D decreases to less than the predetermined value PVa, the control device 1 changes the movement path of the robot 2 to increase the distance D to the predetermined value PVa or greater, and thereby allows the robot 2 to continue the task. As described, the predetermined value PVa is a value for determining, by the distance D, whether to change the movement path of the robot 2. Note that the movement path change is an example of “the approach-handling process” in the present invention.

The control device 1 is further configured to adjust the predetermined value PVa in accordance with the workpiece held by the robot 2. For example, the control device 1 is configured to set the predetermined value PVa to a first value Va1 at normal times when the workpiece is a non-dangerous object (an object other than a dangerous one), and to set the predetermined value PVa to a second value Va2 when the workpiece is a dangerous object. The second value Va2 is greater than the first value Va1. The first value Va1 is a preset value, and represents a separation distance between the robot 2 and the person (a critical distance at which the approach of the person to the robot 2 is allowable) in the case of a non-dangerous workpiece. The second value Va2 is a preset value greater than the first value Va1, and represents a separation distance between the robot 2 and the person in the case of a dangerous workpiece. This arrangement allows the robot 2 to perform the task, with keeping a greater separation distance in the case of a dangerous workpiece than in the case of a non-dangerous workpiece. Examples of a dangerous workpiece include a workpiece having a sharp shape, a high-temperature workpiece, a workpiece that is unstable while being held by the robot 2, a dangerous or hazardous chemical, and the like.

### —Operation of the Robot Control System—

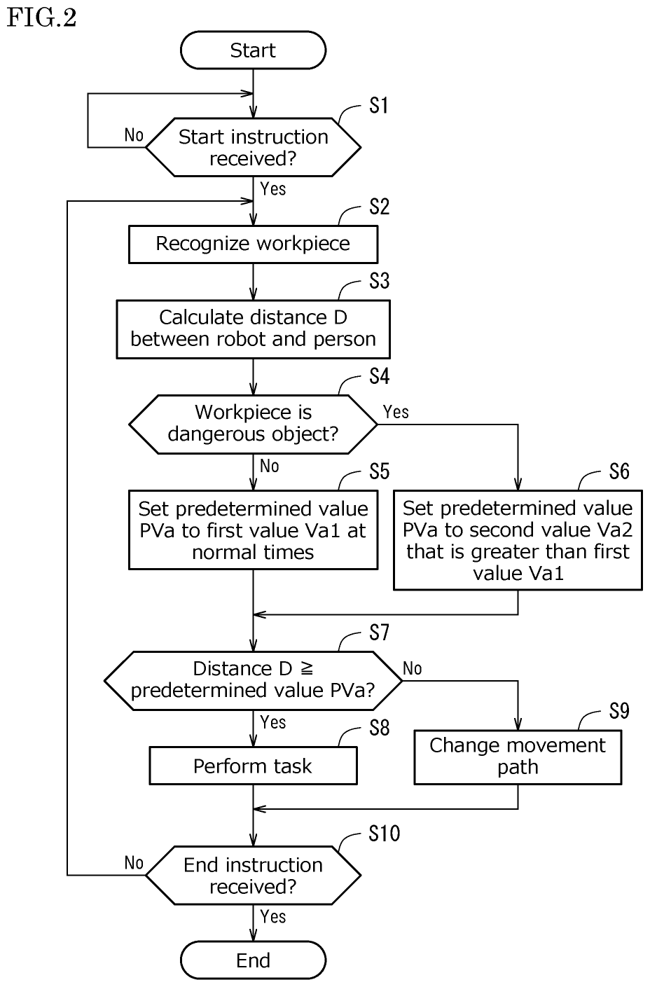

Referring next to FIG. 2, a description is made of an operation of the robot control system 100 according to the first embodiment. The following steps are performed by the control device 1.

In step S1 in FIG. 2, the control device 1 determines whether it has received an instruction to start task execution by the robot 2. If the control device 1 determines that it has received an instruction to start the task execution, the process goes to step S2. On the other hand, if the control device 1 determines that it has not received an instruction to start the task execution, step S1 is repeated. In other words, the control device 1 is on standby until it receives an instruction to start the task execution.

In step S2, the control device 1 recognizes a workpiece held by the robot 2. In step S3, the control device 1 calculates a distance D between the robot 2 and a person. For example, a result of an image captured by the image capturing device 3 is used to recognize the workpiece and calculate the distance D.

In step S4, the control device 1 determines whether the recognized workpiece is a dangerous object. If the workpiece is not determined to be a dangerous object (when the workpiece is a non-dangerous object), the process goes to step S5, where the predetermined value PVa is set to the first value Va1, and then the process goes to step S7. On the other hand, if the workpiece is determined to be a dangerous object, the process goes to step S6, where the predetermined value PVa is set to the second value Va2, and then the process goes to step S7.

In step S7, the control device 1 determines whether the distance D is equal to or greater than the predetermined value PVa. Specifically, when the workpiece is a non-dangerous object, the control device 1 determines whether the distance D is equal to or greater than the first value Va1; when the workpiece is a dangerous object, the control device 1 determines whether the distance D is equal to or greater than the second value Va2. If the distance D is determined to be equal to or greater than the predetermined value PVa, the process goes to step S8, where the task is performed on the preset movement path, and then the process goes to step S10. On the other hand, if the distance D is determined to be neither equal to nor greater than the predetermined value PVa (when the distance D is less than the predetermined value PVa), the process goes to step S9, where the task is performed on the changed movement path of the robot 2, and then the process goes to step S10. In step S9, the changed movement path is set such that the distance D increases to the predetermined value PVa or greater, for example, based on a position of the person or other like factors. In other words, the control device 1 changes the movement path of the robot 2 to keep the separation distance between the robot 2 and the person. Note that the separation distance in the case of a dangerous workpiece is greater than the separation distance in the case of a non-dangerous workpiece.

In step S10, the control device 1 determines whether it has received an instruction to end the task execution by the robot 2. If the control device 1 determines that it has received an instruction to end the task execution, the execution of the task is terminated, and thereafter the process goes to End. On the other hand, if the control device 1 determines that it has not received an instruction to end the task execution, the process returns to step S2. In other words, the control device 1 causes the robot 2 to perform the task repetitively until the control device 1 receives an instruction to end the task execution.

### —Advantageous Effects—

In the first embodiment, the control device 1 changes the movement path of the robot 2 when the distance D between the robot 2 and the person is less than the predetermined value PVa, and thereby allows the robot 2 to continue the task while avoiding interference (collision) of the robot 2 with the person. Consequently, this embodiment can ensure safety and can maintain work efficiency of the robot 2 at the same time. Besides, the control device 1 adjusts the predetermined value PVa in accordance with the workpiece held by the robot 2, which means the control device 1 adjusts, in accordance with the workpiece held by the robot 2, the predetermined value PVa that is a value for determining whether to change the movement path. The control device 1 can therefore change the movement path with suitable timing in accordance with the workpiece. Specifically, the predetermined value PVa is set to the first value Va1 in the case of a non-dangerous workpiece, and the predetermined value PVa is set to the second value Va2 in the case of a dangerous workpiece, wherein the second value Va2 is greater than the first value Va1. As a result, when the distance D is getting smaller and the workpiece turns out to be a dangerous object, the movement path can be changed earlier. In other words, the separation distance in the case of a dangerous workpiece is greater than in the case of a non-dangerous workpiece, which leads to further improvement in safety.

### Second Embodiment

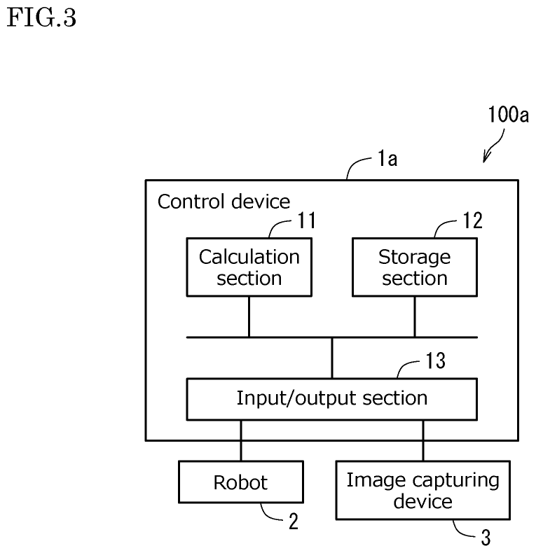

Referring next to FIG. 3, a description is made of a configuration of a robot control system 100a that includes a control device 1a according to the second embodiment of the present invention.

As shown in FIG. 3, the robot control system 100a includes the control device 1a, the robot 2, and the image capturing device 3. Unlike the control device 1 (see FIG. 1), the control device 1a is not configured to change the movement path of the robot 2. In other words, the control device 1a is configured to cause the robot 2 to move along a preset movement path when causing the robot 2 to perform the task.

When the distance D between the robot 2 and the person is equal to or greater than a predetermined value PVb, the control device 1a is configured to cause the robot 2 to perform the task repetitively. While repeating the task, the robot 2 is caused to move, for example, at a preset movement speed. Further, when the distance D decreases to less than the predetermined value PVb and is equal to or greater than a predetermined value PVc, the control device 1a is configured to cause the robot 2 to perform the task repetitively at a reduced movement speed (at a lower movement speed than the preset movement speed). Furthermore, when the distance D decreases to less than the predetermined value PVc, the control device 1a is configured to cause the robot 2 to stop its movement and to suspend the task. After the task by the robot 2 is suspended, the robot 2 is caused to resume the task when the distance D increases to the predetermined value PVc or greater. As described, the predetermined value PVb is a value for determining, by the distance D, whether to reduce the movement speed of the robot 2; the predetermined value PVc is a value for determining, by the distance D, whether to stop the movement of the robot 2. Note that the reduction of the movement speed and the stop of the movement are examples of “the approach-handling process” in the present invention.

The control device 1a is further configured to adjust the predetermined values PVb and PVc in accordance with the workpiece held by the robot 2. For example, the control device 1a is configured to set the predetermined value PVb to a first value Vb1 at normal times when the workpiece is a non-dangerous object, and to set the predetermined value PVb to a second value Vb2 when the workpiece is a dangerous object. The second value Vb2 is greater than the first value Vb1. As a result, the movement speed of the robot 2 is reduced earlier in the case of a dangerous workpiece than in the case of a non-dangerous workpiece. In addition, the control device 1a is configured to set the predetermined value PVc to a first value Vc1 at normal times when the workpiece is a non-dangerous object, and to set the predetermined value PVc to a second value Vc2 when the workpiece is a dangerous object. The second value Vc2 is greater than the first value Vc1. As a result, the movement of the robot 2 is stopped earlier in the case of a dangerous workpiece than in the case of a non-dangerous workpiece.

The first value Vb1, the second value Vb2, the first value Vc1, and the second value Vc2 are preset values. The first value Vb1 is greater than the first value Vc1, and the second value Vb2 is greater than the second value Vc2. As a result, when the distance D is gradually getting smaller, the distance D first falls below the predetermined value PVb and later falls below the predetermined value PVc. In other words, when the distance D is gradually getting smaller, the control device 1a first reduces the movement speed of the robot 2 and later stops the movement of the robot 2.

The other configurations of the control device 1a are substantially similar to those of the control device 1 described above.

### —Operation of the Robot Control System—

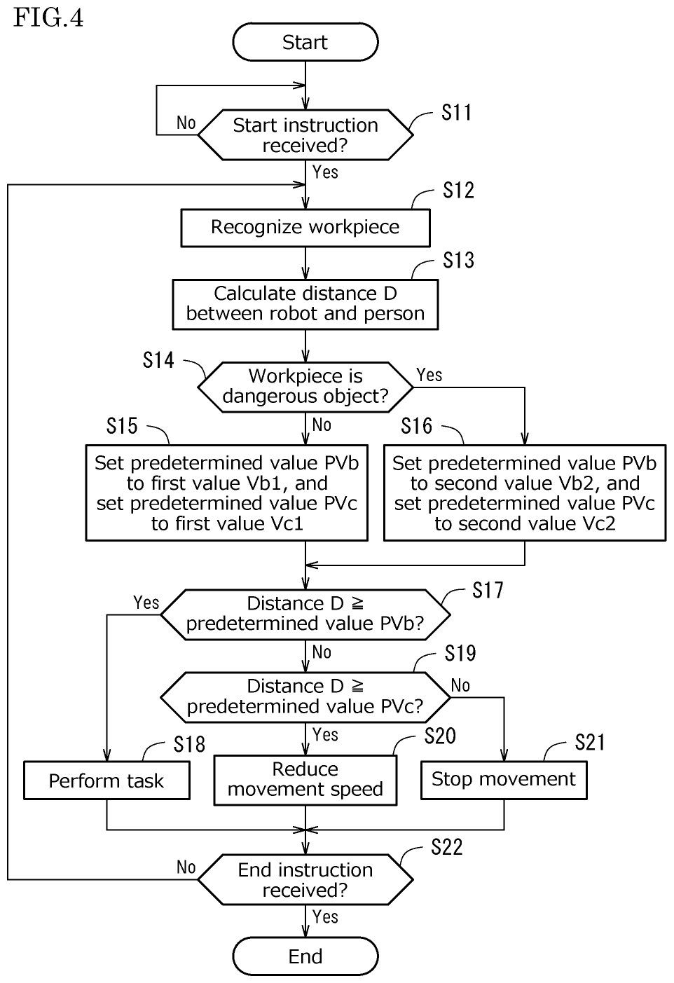

Referring next to FIG. 4, a description is made of an operation of the robot control system 100a according to the second embodiment. The following steps are performed by the control device 1a.

In step S11 in FIG. 4, the control device 1a determines whether it has received an instruction to start task execution by the robot 2. If the control device 1a determines that it has received an instruction to start the task execution, the process goes to step S12. On the other hand, if the control device 1a determines that it has not received an instruction to start the task execution, step S11 is repeated. In other words, the control device 1a is on standby until it receives an instruction to start the task execution.

In step S12, the control device 1a recognizes a workpiece held by the robot 2. In step S13, the control device 1a calculates a distance D between the robot 2 and a person. For example, a result of an image captured by the image capturing device 3 is used to recognize the workpiece and calculate the distance D.

In step S14, the control device 1a determines whether the recognized workpiece is a dangerous object. If the workpiece is not determined to be a dangerous object (when the workpiece is a non-dangerous object), the process goes to step S15, where the predetermined value PVb is set to the first value Vb1 and the predetermined value PVc is set to the first value Vc1, and then the process goes to step S17. On the other hand, if the workpiece is determined to be a dangerous object, the process goes to step S16, where the predetermined value PVb is set to the second value Vb2 and the predetermined value PVc is set to the second value Vc2, and then the process goes to step S17.

In step S17, the control device 1a determines whether the distance D is equal to or greater than the predetermined value PVb. Specifically, when the workpiece is a non-dangerous object, the control device 1a determines whether the distance D is equal to or greater than the first value Vb1; when the workpiece is a dangerous object, the control device 1a determines whether the distance D is equal to or greater than the second value Vb2. If the distance D is determined to be equal to or greater than the predetermined value PVb, the process goes to step S18, where the task is performed at the preset movement speed, and then the process goes to step S22. On the other hand, if the distance D is determined to be neither equal to nor greater than the predetermined value PVb (when the distance D is less than the predetermined value PVb), the process goes to step S19.

In step S19, the control device 1a determines whether the distance D is equal to or greater than the predetermined value PVc. Specifically, when the workpiece is a non-dangerous object, the control device 1a determines whether the distance D is equal to or greater than the first value Vc1; when the workpiece is a dangerous object, the control device 1a determines whether the distance D is equal to or greater than the second value Vc2. If the distance D is determined to be equal to or greater than the predetermined value PVc, the process goes to step S20, where the task is performed at a reduced movement speed (at a lower movement speed than the preset movement speed), and then the process goes to step S22. On the other hand, if the distance D is determined to be neither equal to nor greater than predetermined value PVc (when the distance D is less than the predetermined value PVc), the process goes to step S21, where the movement of the robot 2 is stopped and the task is suspended, and then the process goes to step S22.

In step S22, the control device 1a determines whether it has received an instruction to end the task execution by the robot 2. If the control device 1a determines that it has received an instruction to end the task execution, the execution of the task is terminated, and thereafter the process goes to End. On the other hand, if the control device 1a determines that it has not received an instruction to end the task execution, the process returns to step S12. In other words, except when the robot 2 is stopped, the control device 1a causes the robot 2 to perform the task repetitively until the control device 1a receives an instruction to end the task execution.

### —Advantageous Effects—

In the second embodiment, the control device 1a reduces the movement speed of the robot 2 when the distance D between the robot 2 and the person is less than the predetermined value PVb, and thereby allows the robot 2 to continue the task while preventing interference of the robot 2 with the person. Consequently, this embodiment can prevent deterioration of safety and can prevent deterioration of work efficiency of the robot 2 at the same time. Besides, the control device 1a adjusts the predetermined value PVb in accordance with the workpiece held by the robot 2, which means the control device 1a adjusts, in accordance with the workpiece held by the robot 2, the predetermined value PVb for determining whether to reduce the movement speed. The control device 1a can therefore reduce the movement speed with suitable timing in accordance with the workpiece. Specifically, the predetermined value PVb is set to the first value Vb1 in the case of a non-dangerous workpiece, and the predetermined value PVb is set to the second value Vb2 in the case of a dangerous workpiece, wherein the second value Vb2 is greater than the first value Vb1. As a result, when the distance D is getting smaller and the workpiece turns out to be a dangerous object, the movement speed can be reduced earlier, which leads to further improvement in safety.

In the second embodiment, the control device 1a further causes the robot 2 to stop its movement when the distance D between the robot 2 and the person is less than the predetermined value PVc, and can thereby prevent interference of the robot 2 with the person. Consequently, this embodiment can prevent deterioration of safety. Besides, the control device 1a adjusts the predetermined value PVc in accordance with the workpiece held by the robot 2, which means the control device 1a adjusts, in accordance with the workpiece held by the robot 2, the predetermined value PVc for determining whether to cause the robot 2 to stop its movement. The control device 1a can therefore cause the robot 2 to stop its movement with suitable timing in accordance with the workpiece. Specifically, the predetermined value PVc is set to the first value Vc1 in the case of a non-dangerous workpiece, and the predetermined value PVc is set to the second value Vc2 in the case of a dangerous workpiece, wherein the second value Vc2 is greater than the first value Vc1. As a result, when the distance D is getting smaller and the workpiece turns out to be a dangerous object, the movement of the robot 2 can be stopped earlier, which leads to further improvement in safety.

### Other Embodiments

The embodiments disclosed herein are considered in all respects as illustrative and should not be any basis of restrictive interpretation. The scope of the present invention is therefore indicated by the appended claims rather than by the foregoing embodiments alone. The technical scope of the present invention is intended to embrace all variations and modifications falling within the equivalency range of the appended claims.

For example, the first and second embodiments mention, but are not limited to, the example of causing the robot 2 to transport a workpiece. Alternatively, the robot may process the workpiece or handle the workpiece otherwise.

Also, the first and second embodiments mention, but are not limited to, the example of providing one image capturing device 3 and using a result of an image captured by the single image capturing device 3 to recognize a workpiece and calculate the distance D. Alternatively, an image capturing device for recognizing a workpiece and another image capturing device for calculating the distance between the robot and a person may be provided independently. As a further alternative, a workpiece may be recognized by use of other means than the image capturing device, and the distance between the robot and the person may be calculated by use of other means than the image capturing device.

Also, the first and second embodiments mention, but are not limited to, the example in which the distance D between the robot 2 and the person is the shortest distance from the multi-axis arm of the robot 2, the hand of the robot 2, and the workpiece held by the hand of the robot 2, to the human body. Alternatively, the distance D between the robot and the person may be a distance from the base of the robot to the person, a distance from the hand of the robot to the person, or a distance from the workpiece held by the hand of the robot to the person.

Also, the first and second embodiments mention, but are not limited to, the example of adjusting the predetermined value, based on the danger of the workpiece. Alternatively, the predetermined value may be adjusted, based on the safety of the workpiece.

Also, the first and second embodiments mention, but are not limited to, the example of adjusting the predetermined value in two levels, based on whether the workpiece is a dangerous object. Alternatively, the predetermined value may be adjusted in three or more levels or may be adjusted linearly, based on the danger level of the workpiece.

After the movement path of the robot 2 is changed in the first embodiment, it may be still difficult to keep the separation distance between the robot 2 and the person. In this case, the embodiment may be further arranged to reduce the movement speed of the robot 2 and/or to stop the movement of the robot 2.

As the approach-handling process, the second embodiment mentions, but is not limited to, the example of setting both the reduction of the movement speed of the robot 2 and the stop of the movement of the robot 2. Alternatively, either the reduction of the movement speed of the robot 2 or the stop of the movement of the robot 2 may be set as the approach-handling process.

### INDUSTRIAL APPLICABILITY

The present invention is applicable to a control device, a control method, and a program for controlling a robot that performs a task.

### REFERENCE SIGNS LIST

1, 1a control device (computer)
2 robot
3 image capturing device
11 calculation section
12 storage section
13 input/output section
100, 100a robot control system

1. A control device for controlling a robot that performs a task,
the control device comprising:
a task execution section that causes the robot to perform the task;
an approach-handling process execution section that causes the robot to perform an approach-handling process when a distance between the robot and a person is less than a predetermined value; and
a predetermined value adjustment section that adjusts the predetermined value in accordance with a workpiece held by the robot.

2. A control method for controlling a robot that performs a task, the control method comprising:
causing the robot to perform the task;
causing the robot to perform an approach-handling process when a distance between the robot and a person is less than a predetermined value; and
adjusting the predetermined value in accordance with a workpiece held by the robot.

3. A non-transitory computer-readable storage medium storing a program for causing, when read and executed, a computer to perform operations comprising:
causing a robot to perform a task;
causing the robot to perform an approach-handling process when a distance between the robot and a person is less than a predetermined value; and
adjusting the predetermined value in accordance with a workpiece held by the robot.
